(19) United States
(12) Patent Application Publication
(10) Pub. No.: US 2004/0035202 A1
(43) Pub. Date: Feb. 26, 2004

(54) Method and device for the metered delivery of low volumetric flows of liquid

(76) Inventors: Gerhard Karl Strauch, Aachen (DE); Markus Jakob, Monschau (DE); Johannes Lindner, Aachen (DE)

Correspondence Address: ST. ONGE STEWARD JOHNSTON & REENS, LLC, 986 BEDFORD STREET, STAMFORD, CT, 06905-5619, US

(21) Appl. No.: 10/448,940

(22) Filed: May 30, 2003

Related U.S. Application Data
(63) Continuation of application No. PCT/EP01/13074, filed on Nov. 10, 2001.

(30) Foreign Application Priority Data
Nov. 30, 2000 (DE) 100 59 386.0

(51) Int. Cl. G01F 1/20

(52) U.S. Cl. 73/216

(57) ABSTRACT

The invention relates to a method for the metered delivery of low volumetric flows by the introduction of a gaseous stream into a tank containing a liquid and the displacement of the liquid through a liquid conduit. To improve said method, a partial gaseous stream is diverted from a mass-flow controlled gaseous stream, at a pressure that is maintained at a constant level and that essentially corresponds to the gaseous pressure in the tank, and is guided into said tank to displace the liquid, the mass flow of the partial gaseous stream being measured. A variation in the pressure allows a partial gaseous mass-flow to be set, whose volumetric flow, determined by taking into consideration the gas density, corresponds to the desired value for the liquid volumetric flow.

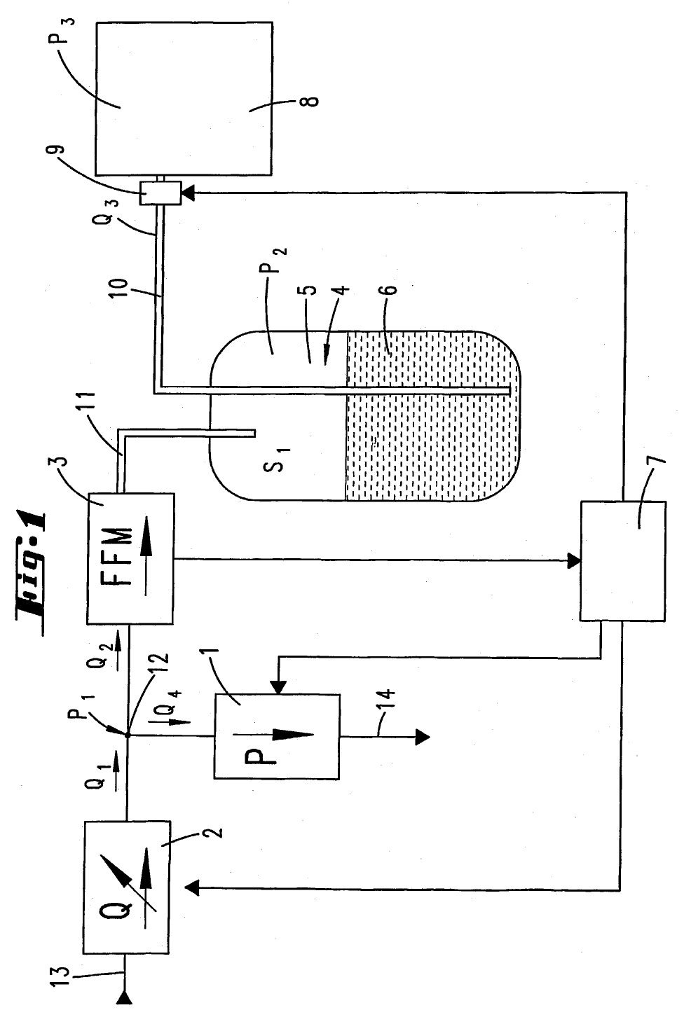

This application is a continuation of pending International Patent Application No. PCT/EP01/13074 filed Nov. 10, 2001, which designates the United States and claims priority of pending German Application No. 100 59 86, filed Nov. 30, 2000.

### FIELD OF THE INVENTION

The invention relates to a method and a device for the metered delivery of low volumetric flows of liquid by introduction of a gas flow into a tank containing a liquid and displacement of the liquid through a liquid line.

A method of this type and a device for carrying out the method are disclosed by WO 99/16929. This document describes an LDS (liquid precursor delivery system). Devices of this type are used to feed gaseous components to a CVD installation. The gaseous components are in this case evaporated, after prior atomization, by contact with a hot surface, for example, or are evaporated directly, for example in a frit, by contact between the liquid and a hot surface. The liquid flows to be metered in that instance often have a level of less than 10 ml/min. Direct measurement of such small volumetric flows causes problems. On the other hand, deposition of, for example, ferroelectric materials from the vapor phase on a semiconductor layer requires reproducible setting and metering of the liquid metal organic strontium, barium, titanium, bismuth or tantalum compounds.

The invention is therefore based on the object of improving the method of the generic type and the device of the generic type.

The object is achieved by the invention described in the claims. Claim 1 provides, firstly and in particular, that a partial gas flow, which is conducted into the tank in order to displace the liquid and the mass flow of which is measured, is branched off from a mass-flow-controlled gas flow at a pressure which is kept constant and substantially corresponds to the gas pressure in the tank, a partial gas mass flow, the volumetric flow of which can be determined with reference to the gas density and corresponds to the desired value of the liquid volumetric flow, being set by varying the pressure. The method is preferably further embodied such that the partial gas flow is smaller than the gas flow by at least a factor of 100. The gas flow is preferably also kept constant in the event of the pressure varying. In a preferred embodiment, it is provided that the liquid volumetric flow, having in particular been brought to a gaseous state, is fed to a CVD reactor. The liquid flow may in this case be atomized in pulsed fashion. The resulting aerosol can be evaporated by the addition of heat.

According to the invention, the device of the generic type is developed by the fact that there is a gas mass flow controller for providing a constant gas flow, from which a partial gas flow, which is conducted into the tank through a gas mass flowmeter which has a low flow resistance, can be branched off at a pressure which is kept constant by means of a pressure controller and substantially corresponds to the gas pressure in the tank, having a control element, by means of which a partial gas mass flow flowing through the gas mass flowmeter can be set by varying the pressure controlled by the pressure controller, so that the corresponding volumetric flow of this partial gas mass flow corresponds to the desired value for the liquid volumetric flow. The device may preferably be associated with a CVD installation as source of a liquid reactant. The liquid flow can furthermore be fed to an, in particular pulsating, atomizer nozzle. The aerosol generated by the atomizer nozzle, after it has been evaporated, can be fed in the gaseous state to a process chamber of a CVD reactor.

An exemplary embodiment of the invention is explained below with reference to the accompanying drawing. The drawing diagrammatically depicts the structure of a device for carrying out the method.

A gas flow, for example hydrogen or nitrogen or another inert gas, flows out of a feed line 13 through a gas mass flow controller 2. The gas flow rate Q1 provided by the gas mass flow controller 2 flows past a branch 12 to a pressure controller 1 which keeps the pressure in the region of the branch point 12 constant at a pressure P1. The excess gas flows out of an outlet line from the pressure controller 1.

A relatively small partial gas flow Q2 is branched off at the branch 12. The partial gas flow Q2 is approximately a hundred times smaller than the gas flow Q1 which substantially flows through the outlet line 14 as gas flow Q4.

The partial gas flow Q2 flows through a gas mass flowmeter 3. The flow resistance of the gas mass flow controller is relatively low. The result of this is that substantially the same pressure P2 which is kept constant at the branch 12 by the pressure controller 1 also prevails in the gas line 11 which leads out of the gas mass flowmeter 3 and into a tank 5.

Therefore, the pressure P2 of the gas 5 in the tank 4 can be kept constant by the pressure controller 1.

The tank 4 contains a liquid 6. A riser pipe 10, which leads to an atomizer nozzle 9 located outside the tank, projects into the liquid 6. The atomizer nozzle 9 may be pulsed and forms an aerosol. The aerosol which emerges from the atomizer nozzle 9 is evaporated in the reaction chamber 8 at a pressure P3 by the addition of heat. The liquid may be a metal organic compound. The process chamber is preferably used to deposit ferroelectric layers on semiconductor surfaces.

The device also has a control element 7 which uses the measured value from the gas mass flowmeter 3 as an input variable. A volumetric flow can be determined from the measured mass flow rate by taking account of the gas density of the gas 5 in the tank 4. The control element 7 regulates this volumetric flow Q2 to a level which corresponds to the desired value for the liquid volumetric flow Q3. For this purpose, the pressure P1 is set by varying the desired value fed to the pressure controller 1 in such a manner that the volumetric gas flow flowing through the gas mass flowmeter 3 corresponds to the desired value of the liquid volumetric flow Q3. The mass flow Q1, which is kept substantially constant and is provided by the gas mass flow controller 2, can likewise be influenced by the control element. The control element 7 can likewise control an atomizer nozzle 9. The atomizer nozzle 9 can be operated continuously or in pulsed fashion.

The method is substantially based on the discovery that the volumetric flow Q2 provides a virtually unambiguous relationship between the measured mass flow rate of the partial gas flow Q2 and its volumetric flow as a function of the geometric conditions of the gas line 11 and the gas mass flowmeter 3 when the temperature is kept constant.

If the liquid volumetric flow Q3 is to be varied, the control element 7 varies the preset value for the pressure controller 1 until a gas mass flow rate which corresponds to the volumetric flow Q3 taking account of the density of the gas 5 at pressure P2 is measured at the gas mass flowmeter 3.

All features disclosed are (inherently) pertinent to the invention. The disclosure content of the associated/appended priority documents (copy of the prior application) is hereby incorporated in its entirety in the disclosure of the application, partly with a view to incorporating features of these documents in claims of the present application.

What is claimed is:

1. Method for the metered delivery of low volumetric flows of liquid by introduction of a gas flow into a tank containing a liquid and displacement of the liquid through a liquid line, characterized in that a partial gas flow (Q2), which is conducted into the tank in order to displace the liquid, is branched off from a mass-flow-controlled gas flow (Q1) at a pressure (P1) which is kept constant and substantially corresponds to the gas pressure (P2) in the tank (4), the mass flow of the partial gas flow (2) being measured, a partial gas mass flow, the volumetric flow of which can be determined with reference to the gas density (Q1) and corresponds to the desired value of the liquid volumetric flow (Q3), being set by varying the pressure (P1).

2. Method according to claim 1 or in particular according thereto, characterized in that the partial gas flow (Q2) is smaller than the gas flow (Q1) by at least a factor of 100.

3. Method according to one or more of the preceding claims or in particular according thereto, characterized in that the gas flow (Q1) is kept substantially constant in the event of the pressure (P1) varying.

4. Method according to one or more of the preceding claims or in particular according thereto, characterized in that the liquid volumetric flow, having in particular been brought to a gaseous state, is fed to a CVD reactor (8).

5. Method according to one or more of the preceding claims or in particular according thereto, characterized in that the liquid volumetric flow (Q3) is atomized, in particular in pulsed fashion, and the aerosol which results is evaporated by the addition of heat.

6. Device for the metered delivery of low volumetric flows of liquid by introduction of a gas flow into a tank containing a liquid and displacement of the liquid through a liquid line, characterized by a gas mass flow controller (2) for providing a constant gas flow (Q1), from which a partial gas flow (Q2), which is conducted into the tank (4) through a gas mass flowmeter (3) which has a low flow resistance, can be branched off at a pressure (P1) which is kept constant by means of a pressure controller (1) and substantially corresponds to the gas pressure (P2) in the tank (4), having a control element (7), by means of which a partial gas mass flow flowing through the gas mass flowmeter (3) can be set by varying the pressure (P1) controlled by the pressure controller (1), so that the corresponding volumetric flow of this partial gas mass flow corresponds to the desired value for the liquid volumetric flow (Q3).

7. Device for the metered delivery of low volumetric flows of liquid, characterized in that the device is associated with a CVD installation as source of a liquid reactant.

8. Device for the metered delivery of low volumetric flows of liquid, characterized in that the liquid flow is fed to an, in particular pulsating, atomizer nozzle (9).

9. Device for the metered delivery of low volumetric flows of liquid, characterized in that the aerosol released by the atomizer nozzle (9) is evaporated by the addition of heat and fed to the process chamber of a CVD reactor.
